(19) United States
(12) Patent Application Publication
(10) Pub. No.: US 2025/0376406 A1
(43) Pub. Date: Dec. 11, 2025

(54) METHOD FOR PRODUCING A PREFORM FOR A HOLLOW-CORE FIBER

(71) Applicant: Heraeus Quarzglas GmbH & Co. KG, Hanau (DE)

(72) Inventors: Manuel ROSENBERGER, Kleinostheim (DE); Andreas MÜLLER, Kleinostheim (DE); Timo SPIELMANN, Kleinostheim (DE); Kay SCHUSTER, Bitterfeld-Wolfen (DE); Jaqueline PLASS, Kleinostheim (DE); Jörg WERNER, Kleinostheim (DE)

(21) Appl. No.: 19/225,722

(22) Filed: Jun. 2, 2025

(30) Foreign Application Priority Data
Jun. 6, 2024 (EP) 24180450.9

(51) Int. Cl. C03B 37/012

(52) U.S. Cl. CPC C03B 37/01208; C03B 37/01254

(57) ABSTRACT

A method for producing a preform for an anti-resonant hollow-core fiber which comprises a hollow core extending along a longitudinal axis of the fiber and a sheath that surrounds the hollow core and through which hollow channels pass.

### CROSS-REFERENCE TO RELATED APPLICATIONS

This application claims priority pursuant to 35 U.S.C. 119(a) to European Patent Application No. 24180450.9, filed Jun. 6, 2024, which application is incorporated herein by reference in its entirety.

### TECHNICAL BACKGROUND

The invention relates to the field of optical fiber technology and, in particular, to the area of anti-resonant hollow-core fibers (AR-HCF for short). The hollow core region is surrounded by a microstructured sheath in which so-called “anti-resonant elements” (“AREs” for short) are arranged. These usually form hollow channels that are separated from each other by glass membranes. The glass membranes arranged around the hollow core can reflect the incoming light and thus guide it through the fiber core. Hollow-core fibers therefore allow light to be guided within a “hollow” core that is either evacuated or filled with a gas (such as air).

This fiber technology promises low optical attenuation, a very broad transmission spectrum (even in the UV or IR wavelength ranges), and low latency period during data transmission. In addition, these fibers are suitable for spectroscopic applications as well as for the transmission of short laser pulses for high-power beam guidance, e.g., for material processing, modal filtering, nonlinear optics, in particular for supercontinuum generation, from the ultraviolet to the infrared wavelength range.

In particular, the invention relates to a method for producing a preform for an anti-resonant hollow-core fiber comprising a hollow core extending along a longitudinal axis of the fiber and a microstructured sheath region surrounding the hollow core.

### BACKGROUND

It is known to draw anti-resonant hollow-core fibers from preforms that have a hollow core which is surrounded by a sheath in which at least some of the ARE's are arranged as a cross-sectional structure traversed by hollow channels. The preform is produced, for example, by collapsing and/or elongating a cylindrical preliminary product, which can then be covered with additional sheath material. The cylindrical preliminary product is, for example, an ensemble consisting of a cladding tube and a plurality of cylindrical starting components, or it is a solid hollow cylinder comprising the hollow core and the sheath traversed by hollow channels, and which is also referred to below as the “core preform” (or cane). The core preform can be obtained by collapsing and/or elongating cylindrical starting components in a cladding tube, wherein additional sheath material can also be collapsed in this method step by overlaying using an overlay cylinder. Starting components of the preliminary product, which form the cross-sectional structure traversed by hollow channels in the preform and the AREs in the finished hollow core fiber, are also referred to below as “ARE preforms”.

An intermediate product for a hollow-core fiber with the so-called NANF (nested anti-resonant nodeless hollow-core fibers) design contains nested ARE preform blanks, in the simplest case each consisting of an outer tube (hereinafter also referred to as “primary tube”) and an inner tube (hereinafter also referred to as “secondary tube”), which is arranged on the inner side of the primary tube.

In a DNANF design (double nested anti-resonant nodeless hollow core fibers), an additional inner tube, which can also be referred to as a “tertiary tube,” is arranged in the secondary tube. The secondary and tertiary tubes form additional hollow channels in the hollow core fiber, which contribute to reducing optical fiber attenuation by causing multiple radial reflections and avoiding transitions or nodes that cause resonances.

In the so-called “ALIF” (anti-resonant leakage-inhibited fibers) design, a pair of secondary tubes are inserted on the inside of the primary tube, which are spaced apart and attached at azimuthal locations around the circumference of the primary tube, both offset from the peripheral contact point of the primary tube on the cladding tube. There is therefore an open gap between each pair of secondary tubes in radial direction.

Polarization-maintaining hollow core fibers contain AREs in which the arrangement of the primary tubes and secondary tubes or the hollow channels created from them has an asymmetry that leads to a preferential conduction of light of one polarization.

EP 3 766 849 A1 discloses a method for producing a preform blank for anti-resonant hollow-core fibers, which is obtained by thermally stretching an intermediate product which is present as an ensemble of a cladding tube and a plurality of ARE preform blanks. On the one hand, it is proposed to set a large draw ratio in order to reduce absolute geometric errors. On the other hand, a large draw-down ratio is associated with correspondingly large forming processes and material movements, which can easily lead to undesired deformations in the delicate structural elements of the anti-resonance clement preforms. The draw ratio during thermal stretching of the intermediate product is therefore preferably set to a value in the range from 1.05 to 10, particularly preferably to a value in the range from 1.05 to 5. During thermal stretching, the intermediate product can be overlaid with additional sheath material in the form of an overlay cylinder.

### TECHNICAL PROBLEM

During thermal stretching of the intermediate product, the latter is fed to a heating device starting from one end and at a feed rate, softened in certain regions therein, and a preform or a fiber is drawn in the drawing direction continuously from the softened region and at a withdrawal rate. The drawing direction can have any orientation in space; usually it is vertical or horizontal. This creates a deformation zone, which is also referred to as a “drawing bulb.”

In order to comply with resonance or anti-resonance conditions, even small dimensional deviations on the order of magnitude of the working wavelength of the light to be guided are not tolerable. Therefore, the dimensionally precise production of the complex cross-sectional structures of the hollow core fiber represents a major challenge. Dimensional deviations can occur due to unwanted deformations during preform production. These are, in particular, deviations in the azimuthal position of the ARE preform blanks during thermal stretching of an ensemble in which the ARE preform blanks are arranged in a cladding tube more or less movably and deformably, in particular bendably.

### SUMMARY OF THE INVENTION

Known methods for producing a preform for an anti-resonant hollow-core fiber, which comprises a hollow core extending along a longitudinal axis of the fiber and a sheath that surrounds the hollow core and through which hollow channels pass, comprise at least one thermal stretching process in which an intermediate product containing anti-resonant preform blanks (ARE preform blanks) is elongated to form the preform. In order to avoid unintentional deformations and changes in the cross-sectional structure, in particular changes in the position of ARE preform blanks, it is proposed for a first cylindrical intermediate product VP1 with a first outer diameter OD1 to be thermally stretched by means of a first draw ratio AV1 which is less than 1.4 to form a second cylindrical intermediate product VP2 with a second outer diameter OD2, and for the latter to be thermally stretched by means of a second draw ratio AV2 to form the preform or to form a third cylindrical intermediate product VP3 with a third outer diameter OD3.

An object of the invention is therefore to provide a method for producing a preform for an anti-resonant hollow-core fiber, in which, during thermal stretching of the intermediate product into the preform, in particular an intermediate product in the form of an ensemble, unintended deformations and changes in the cross-sectional structure, in particular changes in the position of ARE preform blanks, are avoided, so that as a result the hollow channels of the cross-sectional structure in the preform assume the predetermined azimuthal position as precisely as possible.

This object is achieved by a method having the features of claim 1. Advantageous embodiments of the method are indicated in the dependent claims. The method comprises in particular the following method steps:
(a) providing a first cylindrical intermediate product VP1 that has a first outer diameter OD1.

The first intermediate product is typically an ensemble of cladding tube and ARE preform blanks and, if applicable, an overlay cylinder, or it is a preform blank produced from such an ensemble by thermal stretching.

In the ensemble, the ARE preform blanks can be fixed to the inner side of the cladding tube and, in particular, at points on the inner side of the cladding tube ends. In the case of nested ARE preform blanks, such as those found in NANF, DNANF or ALIF designs, the individual starting components forming the nested ARE preform blank can be connected to each other at points, or they can be present as a prefabricated ARE preform blank in which the individual starting components are fused together over a large area and together form a manageable, self-supporting structure.
(b) The first intermediate product VP1 with the outer diameter OD1 is further processed by two thermal stretching steps to form the preform or a third intermediate product. The preform or the third intermediate product has the target outer diameter OD3.

During thermal stretching, the intermediate product is heated in the heating zone from the outside to the inside. A radial temperature gradient from the outside (hot) to the inside (cold) is created within the intermediate product, which leads to a drop-shaped or bulb-shaped deformation zone, which is also referred to as a “drawing bulb.” The forming of the initial outer diameter OD1 into the target outer diameter OD3 can take place along a comparatively short distance. The drawing bulb would then have a short length when seen in projection (shadow projection). Or the forming of the outer diameter OD1 into OD3 can take place along a comparatively long distance. The drawing bulb would then have a great length.

With “long drawing bulbs,” the material transport processes for forming are slower and therefore “gentler” for the delicate cross-sectional structure of the inner sheath region of the intermediate product. On the other hand, the delicate cross-sectional structure is exposed to very high drawing temperatures for a comparatively long time, which can also lead to unpredictable deformations.

For this reason the invention does not use the short drawing bulb or the long drawing bulb route to reach the target diameter OD3 from the initial outer diameter OD1, but proposes an intermediate route with at least a two-stage thermal stretching process.

The first stage of this thermal stretching process is characterized by a particularly small draw ratio of less than 1.3. On the one hand, this means that the material transport processes for forming are slower and therefore “gentler”; on the other hand, the time during which the delicate cross-sectional structure is exposed to the high drawing temperatures is short. This is particularly important for the first stage of the thermal stretching process, when ARE preform blanks are not, or not completely, integrated in the first intermediate product by fusion bonding and therefore have a certain degree of inherent mobility. This can result in longitudinal sections of the ARE preform blanks not following the forming process or only following it partially, in particular during strong forming processes, which ultimately causes a deviation from the predetermined cross-sectional structure over the length of the intermediate product or preform. If the deviation from the predetermined cross-sectional structure is so great that contact occurs between adjacent ARE preform blanks, this means failure and loss of the intermediate product or preform.

In the first stage of the multi-stage thermal stretching process, a second intermediate product VP2 with the outer diameter OD2 is thus produced by thermal stretching from VP1 with the outer diameter OD1, wherein the thermal stretching process from VP1 to VP2 is characterized by a small draw ratio of less than 1.4 and in particular of less than 1.28, which is particularly preferably between 1.002 and 1.25.

This ensures that a stable cross-sectional structure is obtained in the second intermediate product VP2 without unintentional deformations and changes, in which in particular the former ARE preform blanks are fully integrated by fusion over their entire length.
(c) In order to achieve the target outer diameter OD3, the at least two-stage thermal stretching process comprises, in the second stage, thermal stretching of the second intermediate product VP2 with a second draw ratio AV2 to form the preform or a third cylindrical intermediate product VP3 which is further processed to form the preform.

The cross-sectional structure in the second preform is stabilized in the sense that it has fully integrated ARE preform blanks over its entire length solely by fusion. For this reason, the second draw ratio AV2, by means of which the target outer diameter OD3 is set, can be arbitrarily large; it can be in particular smaller or larger than AV1, without risking deformations and changes in the cross-sectional structure. For reasons of efficiency, AV2 is advantageously greater than 1.2, preferably greater than 1.25 and particularly preferably greater than 1.3.

In particular with regard to a forming process that is as gentle as possible in the first stage of the thermal stretching process, a procedure is advantageous in which the ratio of the drawing bulb length L_{Z} in relation to the ratio of the outer diameters OD2 and OD1 on the one hand is large and on the other hand the conicity or constriction of the drawing bulb is as small as possible. One measure of this is the “central constriction angle.” Accordingly, during thermal stretching of the first intermediate product VP1 according to method step (b), a drawing bulb with a drawing bulb length L_{Z} is formed, wherein the central constriction angle ε is less than 5 degrees, preferably less than 4 degrees and particularly preferably less than 3 degrees.

Preferably, the first intermediate product has a large outer diameter in the sense that the first outer diameter OD1 is in the range from 30 to 230 mm, preferably in the range from 35 to 160 mm, particularly preferably in the range from 38 to 120 mm. Accordingly, the second intermediate product obtained from the first intermediate product by slight thermal stretching is also comparatively thick-walled in the sense that the second outer diameter OD2 is preferably in the range from 25 to 200 mm, preferably in the range from 35 to 120 mm.

In contrast, the third intermediate product obtained from the second intermediate product by thermal stretching has an outer diameter OD3 which is preferably in the range from 5 to 100 mm, preferably in the range from 8 to 60 mm.

In a particularly advantageous embodiment of the method, it is provided for the first cylindrical intermediate product VP1 to be an ensemble that comprises a cladding tube with a cladding tube longitudinal axis and a wall inner side, as well as a plurality of cylindrical ARE preform blanks arranged on the wall inner side.

In this ensemble, which is also referred to in the literature as “primary preform,” the ARE preform blanks are preferably not connected or only connected at certain points to the inner side of the cladding tube, for example at one cladding tube end or at both cladding tube ends. This allows the ARE preform blanks to retain a certain degree of flexibility during thermal stretching. The ARE preform blanks are available as simple tubes or capillaries or they are nested ARE preform blanks consisting of at least two structural elements that can be connected to each other at least at certain points.

Here, a first embodiment of the first intermediate product advantageously has an outer diameter of at least 35 mm, for example an outer diameter in the range from 40 to 90 mm. In another embodiment, the first intermediate product advantageously has an outer diameter of greater than 90 mm. The larger outer diameter results, for example, from the fact that the first cylindrical intermediate product VP1 comprises a cladding tube with a large wall thickness and a large outer diameter.

The wall thickness of the cladding tube is, for example, in the range from 20 to 75 mm and the outer diameter in the range from 60 to 200 mm.

In the first intermediate product VP1, ARE preform blanks or individual starting components can loosely rest against their target position on an adjacent wall. By thermally stretching the first intermediate product VP1, all ARE preform blanks are stretched and fused with the respective wall. In this regard, a procedure is preferred in which the second cylindrical intermediate product VP2 is a first preform blank.

The preform blank (cane) is a joined, solid hollow cylinder comprising the hollow core and the sheath through which hollow channels pass.

The third cylindrical intermediate product VP3 is advantageously also a preform blank, i.e. in this case a second preform blank whose outer diameter OD3, in accordance with the second draw ratio AV2, is smaller than the outer diameter OD2 of the first preform blank.

In a preferred procedure, a thermal stretching process comprising at least three stages is provided, wherein the further processing of the third cylindrical intermediate product VP3 comprises thermal stretching of the third intermediate product VP3 and simultaneous overlaying using an overlay cylinder.

### DEFINITIONS

Individual method steps and terms of the above description are further defined below. The definitions are part of the description of the invention. In the event of a substantive inconsistency between one of the following definitions and the rest of the description, the statements made elsewhere in the description take precedence.

For terms and measurement methods that are not specifically defined in the description, the interpretation according to the International Telecommunication Union (ITU) shall apply. Where no measurement method is specified for a parameter, the standard measurement method shall be used for that parameter and, in particular, the measurement method laid down in the relevant ISO standard whose publication date is closest to that of the present application. Should measurement conditions not have been specified, the standard conditions (SATP conditions) for the temperature will be 298.15 K (25° C., 77° F.) and for the absolute pressure 100 kPa (14.504 psi, 0.986 atm).

### Anti-Resonance Elements

Anti-resonant elements can be simple or interleaved structural elements of the hollow core fiber. They comprise at least two walls which, viewed from the direction of the hollow core, have a negative curvature (convex) or no curvature (flat, straight). They generally consist of a material that is transparent to the working light, e.g., glass, in particular doped or non-doped SiO₂, a plastic, in particular a polymer, a composite material, or a crystalline material. Preform

The preform is the component or component ensemble from which the anti-resonant hollow core fiber is drawn using a fiber drawing process. The core-sheath-cross-sectional structure of the hollow core fiber can already be geometrically designed in the preform by the relative arrangement of the ARE preforms to each other or the hollow channels created from them and their angular distribution. However, the size ratios of the hollow channels are often changed during the fiber drawing process.

### Preform—Intermediate Product—Ensemble—Preform Blank

The preform is obtained by thermally stretching a preform precursor once or several times. The preform preliminary product (for short: preliminary product) is, for example, a more or less loose ensemble of cylindrical starting components (stack; here also referred to as “ensemble” or “primary preliminary product”) or it is a joined, solid hollow cylinder that comprises the hollow core and at least the sheath traversed by hollow channels (cane; here also referred to as “core preliminary product” or “secondary preliminary product”). In the ensemble, the cylindrical starting components and the cladding tube can be partially fused together, especially at the cladding tube ends. In the core preform, which can be obtained by collapsing and/or thermally drawing the ensemble, the starting components are usually connected to the cladding tube over their entire length.

Further processing the preform precursor results in either the preform or another preform precursor and can involve a single or repeated execution of one or more of the following hot forming processes:
(i) thermal stretching,
(ii) collapse,
(iii) collapse and simultaneous thermal stretching,
(iv) collapse of additional sheath material,
(v) collapse of additional sheath material and subsequent thermal stretching,
(vi) collapse of additional sheath material and simultaneous thermal stretching.

### Anti-Resonance Element Preform

Anti-resonant element preform blanks are cylindrical starting components of a preform intermediate product in the form of a component ensemble, which are arranged for example in a cladding tube inner bore. They are substantially transformed by thermal drawing to form hollow channels in another preliminary product or to form the preform, and they ultimately form the anti-resonant elements in the hollow core fiber. Nested anti-resonant element preform parts form nested anti-resonant elements in the hollow-core fiber. They are composed of a primary tube and at least one additional structural element that is arranged in the inner bore of the primary tube. The at least one further structural element can be an additional tube that abuts the inner lateral surface of the primary tube. The further tube is referred to here as the “secondary tube.”

In the inner bore of the secondary tube, at least one further structural element can be arranged in the case of multiple nested anti-resonant element preforms, for example a third tube abutting the inner lateral surface of the nested secondary tube.

A prefabricated ARE preform is a self-supporting structure that contains a primary tube and at least one secondary tube that is connected to the inner side of the primary tube so that the primary tube and secondary tube can be handled together in the form of the structure.

### Thermal Stretching/Collapsing

The preliminary product is thermally drawn (elongated) to form the preform. The stretching can take place without simultaneous collapse. The fiber drawing process is also based on a thermal drawing process. The fiber drawing process for hollow core fibers is often not a ratio drawing.

In the collapse process, an inner bore is narrowed or annular gaps between the tubular component are closed or narrowed. Collapse can be combined with thermal stretching.

### Extraction Ratio

Ratio of the component outer diameters before and after thermal drawing.

### Drawing Bulb

A method for determining the length of the drawing bulb is explained below taking the example of thermal stretching process of a cylindrical first intermediate product VP1 with an outer diameter OD1 to a cylindrical second intermediate product VP2 with an outer diameter OD2 in the vertical drawing direction.

The drawing bulb is measured after completion of the stretching process. The “beginning” of the drawing bulb is defined as the height position h1 at which the following applies to the location-dependent outer diameter D_{Z} of the drawing bulb: D_{Z1}=OD1−1/10×(OD1−OD2). Correspondingly, the “end” of the drawing bulb marks the height position h2 at which the following applies to the location-dependent outer diameter D_{Z} of the deformation zone: D_{Z2}=OD2+1/10×(OD1−OD2).

The length of the drawing bulb L_{Z} is therefore the distance between the height positions: L_{Z}=h1(D_{Z1})−h2(D_{Z2}). On the basis of the measurable length L_{Z} and the dimensions D_{Z1} and D_{Z2}, a characteristic central constriction angle ε can be calculated for the drawing bulb.

These definitions of the drawing bulb length and of the central constriction angle are not limited to a drawing bulb such as is formed during thermal stretching with the longitudinal axis of the first intermediate product VP1 oriented vertically. Accordingly, the length of the drawing bulb is defined also in the case of stretching processes for other intermediate products and in particular when the longitudinal axis is oriented horizontally.

### Cross-Section/Inner Bore

The term “cross-section,” in connection with elongated components such as ARE preforms, preform, or hollow core fiber, always denotes the cross-section perpendicular to the corresponding longitudinal axis and, unless stated otherwise, in the case of tubular components, denotes the cross-section of the outer contour (not the cross-section of the inner contour).

The designation “tube inner face” is also used as a synonym for “tube inner lateral surface,” and the designation “tube outer face” is also used as a synonym for “tube outer lateral surface.” The term “inner bore” in conjunction with a tube does not indicate that the inner bore has been produced by a drilling process.

### BRIEF DESCRIPTION OF THE DRAWINGS

The invention is explained in more detail below with reference to an exemplary embodiment and a drawing. In detail, in a schematic representation,

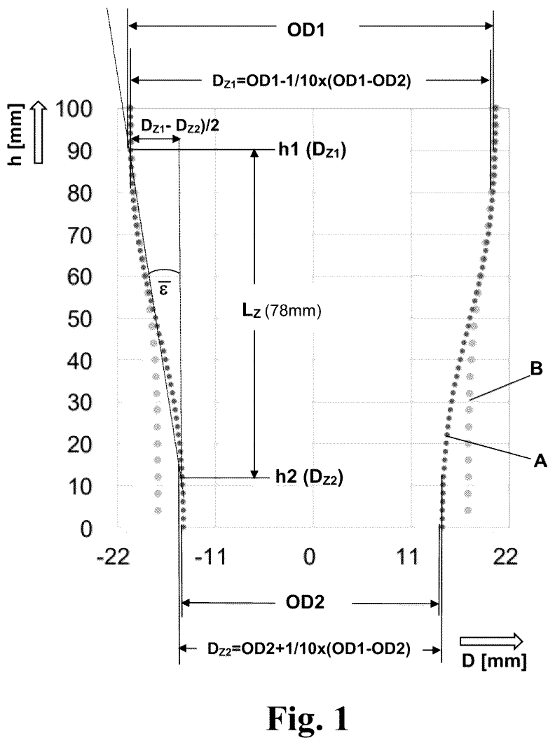

FIG. 1 shows a diagram for determining geometric data of a drawing bulb;

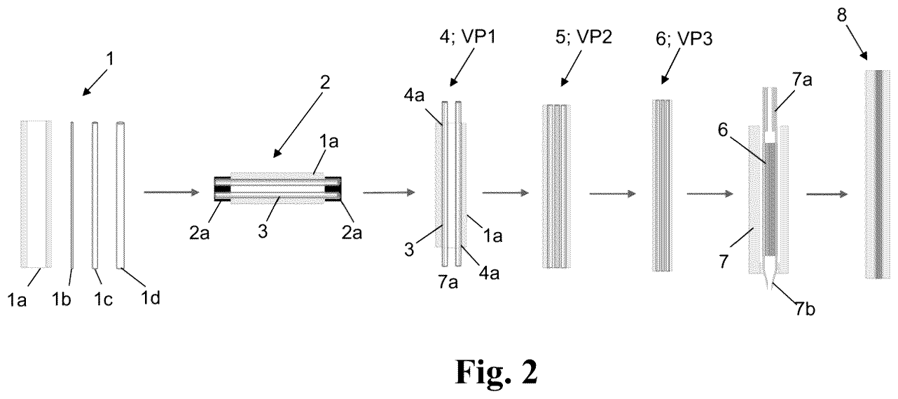

FIG. 2 shows method steps for producing a preform for a hollow-core fiber by means of a first procedure;

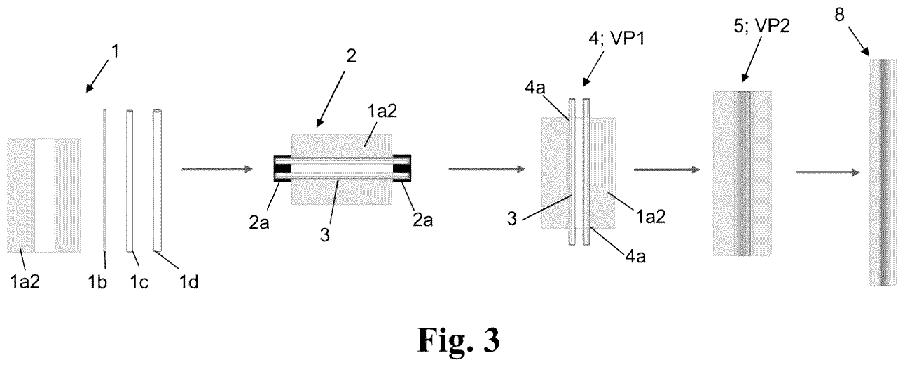

FIG. 3 shows method steps for producing a preform for a hollow-core fiber by means of a second procedure;

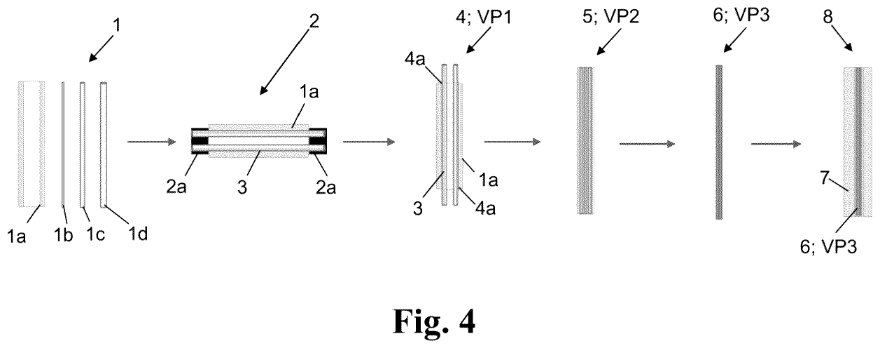

FIG. 4 shows method steps for producing a preform for a hollow-core fiber by means of a third procedure;

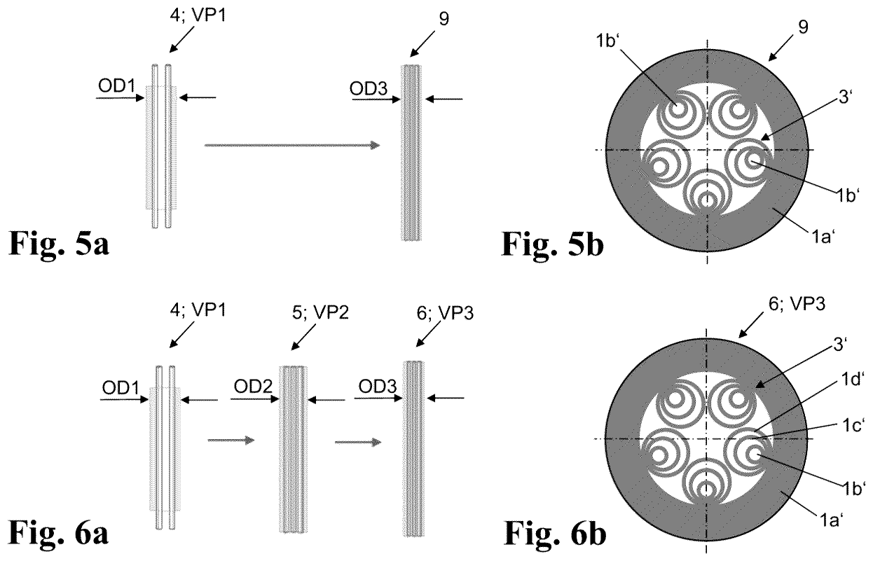

FIG. 5a shows a simple thermal stretching process for producing an intermediate product;

FIG. 5b shows a cross-section of the intermediate product after the simple thermal stretching process;

FIG. 6a shows a twofold thermal stretching process for producing an intermediate product, and,

FIG. 6b shows a cross-section of the intermediate product after the simple thermal stretching process.

### DETAILED DESCRIPTION OF THE INVENTION

FIG. 1 schematically shows two “wide” drawing bulbs A, B with a comparatively small constriction angle, as typically formed in a first thermal stretching process in which a first intermediate product VP1 is elongated to form a second intermediate product VP2. In the diagram, a height or length unit h (in mm) is plotted on the Y-axis against the one intermediate product diameter D (in mm).

The first intermediate product VP1 is a component ensemble having an outer diameter of 41 mm. Drawing bulb A belongs to a drawing process in which the second intermediate product VP2 (sample 10 in Table 1) is a preform blank having an outer diameter of 28 mm, and drawing bulb B belongs to a drawing process in which the second intermediate product VP2 (sample 8 in Table 1) is a preform blank having an outer diameter of 35 mm. For drawing bulb A, a drawing bulb length L_{Z} of 78 mm can be read off from the diagram using the method mentioned in the definitions and a central constriction angle of 3.8 degrees can be calculated therefrom. For drawing bulb B, on the basis of a drawing bulb length L_{Z} of 78 mm a central constriction angle of 1.8 degrees can be calculated.

### Production of a First Intermediate Product—Method Variant 1

FIG. 2 schematically shows starting components 1 for producing a hollow-core fiber with the DNANF design. They include a cladding tube 1a, tertiary tubes 1b, secondary tubes 1c and primary tubes 1d. The cladding tube 1a has an outer diameter of 39 mm and an inner diameter of 22.5 mm.

A tertiary tube 1b, a secondary tube 1c and a primary tube 1d are each combined to form an ARE preform blank 3 and mounted on the inner side of the cladding tube 1a and combined to form a component assembly 2 using an alignment template 2a.

In the region of the front ends of the cladding tube 1a, the ARE preform blanks 3 are fused to the inner side of the cladding tube at points by means of melting points 4a. The alignment template (2a) is then removed. The thus produced more or less loose ensemble of cladding tube 1a and ARE preform blanks 3 has an outer diameter OD1 which is determined by the outer diameter of the cladding tube 1a. It is subjected to a multi-stage thermal stretching process and thus forms the first intermediate product 4 (VP1) within the meaning of the invention (sample 5 in Table 1).

### Multi-Stage Thermal Stretching—Method Variant 1

The first intermediate product 4 (VP1) is elongated by a first thermal stretching into a second intermediate product 5 (VP2) and this is elongated by a second thermal stretching into a third intermediate product 6 (VP3).

A small draw ratio AV1 1.26 is set during thermal stretching of the first intermediate product 4 (VP1). As a result, the material transport processes for forming are slower and therefore “gentler.” In addition, the feed rate can be increased so that the heating time during which the ARE preform blanks 3 are exposed to particularly high drawing temperatures is comparatively short. The ARE preform blanks 3 are deformed only slightly and largely retain their predetermined position and structural integrity, and they are fused to the inner side of the cladding tube 1a.

Slow and gentle forming of the first intermediate product 4 is evidenced by the fact that the drawing bulb has a slight constriction, as shown in FIG. 1 with the aid of two other exemplary embodiments. The decisive factors are feed rate, heating zone length and maximum temperature during thermal stretching. In the exemplary embodiment, the feed rate is 20 mm/min, the heating zone length is 78 mm and the maximum temperature is 1880° C.

In the first stage of the multi-stage thermal stretching process, the second intermediate product 5 (VP2) with the outer diameter OD2 of 31 mm is thus produced by thermal stretching from the first intermediate product 4 (VP1) with the outer diameter OD1 of 39 mm.

The second intermediate product 5 (VP2) is a solid so-called preform blank in which the hollow-core region is surrounded by a sheath region through which hollow channels pass.

In the second stage of the multi-stage thermal stretching process, the second intermediate product 5 (VP2) with the outer diameter OD2 is thermally stretched with a second draw ratio AV2 to produce a third cylindrical intermediate product 7 (VP3) with the outer diameter OD3 of 20 mm. The draw ratio AV2 is 1.55, which is greater than AV1.

### Further Processing to Form the Preform—Method Variant 1

The third intermediate product 6 (VP3) is further processed to form a preform 8. For this purpose, it is overlaid using an overlay cylinder 7, which provides additional sheath material sufficient to adjust the predetermined core-sheath-cross-sectional structure of the hollow-core fiber. During overlaying using the overlay cylinder 7 with vertically oriented longitudinal axis, a holding rod 7a is welded to the upper end of the intermediate product 6 (VP3) and a drawing tip 7b to the lower end. Preform 8 is obtained by simultaneous collapsing and elongation. From this, the hollow-core fiber is drawn by means of a standard fiber drawing process.

Table 1 summarizes the dimensions and method parameters of the multi-stage thermal stretching process for sample 5 described in detail above and for other samples.

TABLE 1

| | OD1 | OD2 | | Lz | □ | suit- | OD3 | | suit- |
|---|---|---|---|---|---|---|---|---|---|
| No | [mm] | [mm] | AV1 | [mm] | degrees | able | [mm] | AV2 | able |
| 1 | 30 | 27 | 1.11 | 78 | 0.9 | yes | 15 | 1.80 | yes |
| 2 | 30 | 25 | 1.20 | 78 | 1.5 | yes | 20 | 1.25 | yes |
| 3 | 34 | 30 | 1.13 | 78 | 1.2 | yes | 23 | 1.30 | yes |
| 4 | 34 | 27 | 1.26 | 78 | 2.1 | yes | 8 | 3.38 | yes |
| 5 | 39 | 31 | 1.26 | 78 | 2.4 | yes | 20 | 1.55 | yes |
| 6 | 41 | 38 | 1.08 | 78 | 0.9 | yes | 24 | 1.58 | yes |
| 7 | 41 | 38 | 1.08 | 78 | 0.9 | yes | 10 | 3.80 | yes |
| 8 | 41 | 35 | 1.17 | 78 | 1.8 | yes | 24 | 1.46 | yes |
| 9 | 41 | 29 | 1.41 | 82 | 3.4 | no | | | |
| 10 | 41 | 28 | 1.46 | 78 | 3.8 | no | | | |
| 11 | 41 | 24 | 1.71 | 90 | 4.3 | no | | | |
| 12 | 56 | 50 | 1.12 | 78 | 1.8 | yes | 30 | 1.67 | yes |
| 13 | 56 | 48 | 1.17 | 78 | 2.4 | yes | | | |
| 14 | 90 | 80 | 1.13 | 78 | 2.9 | yes | 45 | 1.78 | yes |
| 15 | 90 | 45 | 2.00 | 100 | 10.4 | no | | | |
| 16 | 110 | 90 | 1.22 | 140 | 3.3 | yes | 40 | 2.25 | yes |
| 17 | 110 | 40 | 2.75 | 140 | 11.5 | no | | | |
| 18 | 140 | 120 | 1.17 | 140 | 3.3 | yes | 60 | 2.00 | yes |
| 19 | 200 | 180 | 1.11 | 150 | 3.3 | yes | 100 | 1.80 | yes |

Legend:
OD1 Outer diameter of the first intermediate product
OD2 Outer diameter of the second intermediate product
OD3 Outer diameter of a third intermediate product or preform
AV1 Draw ratio in the first thermal stretching process
AV2 Draw ratio in the second thermal stretching process
Lz Length of the drawing bulb (empirically determined)
ε̅ Central constriction angle of the drawing bulb (calculated)
“Suitable - no”: The dimensional accuracy or cross-sectional geometry of the intermediate product after the thermal stretching process is such that further processing is not advisable.

Samples 9, 10, 11, 15 and 17 are comparative examples. They have proven to be unsuitable for further processing into preforms already after the first thermal stretching, which is attributed to the comparatively large draw ratio AV1 of these samples. FIG. 5a schematically shows the one-stage thermal stretching from the first intermediate product 4 (VP1) directly into a cylindrical intermediate product 9 with the outer diameter OD3.

FIG. 5b schematically shows the cross-section of the intermediate product 9 and the reason for its unsuitability for further processing into the preform for the hollow-core fiber. This is because the five previously nested ARE preform blanks 3′ are evenly distributed within the former cladding tube 1a′. However, in particular some of the nested former tertiary tubes 1b′ show significant deviations from their target position.

In comparison, FIG. 6a schematically shows a two-stage thermal stretching of the first intermediate product 4 (sample 5 of Table 1) with the outer diameter OD1, first with a small draw ratio relative to the second intermediate product 5 (VP2) with the outer diameter OD2 and only then with a higher draw ratio relative to the third intermediate product 6 (VP3) with the outer diameter OD3. As shown in FIG. 6b on the basis of the cross-section of said intermediate product 6 (VP3), the five former nested ARE preform blanks 3′ are evenly distributed within the former cladding tube 1a′ and fused to the inner side of the cladding tube. The nested former tertiary tubes 1b′, secondary tubes 1c′ and primary tubes 1d′ also show no deviations from their target position. For this reason, the intermediate product 6 of sample 5 is suitable for further processing into a preform.

Insofar as the same reference numerals are used in the method variants 2 and 3 explained below as in FIG. 1, they designate identical or equivalent components, constituents or process measures as explained above with reference to method variant 1.

### Production of a First Intermediate Product—Method Variant 2

Compared to the method variant 1, the starting components 1 in the method variant 2 schematically shown in FIG. 3 comprise a particularly thick-walled cladding tube 1a2 having an outer diameter of 90 mm and an inner diameter of 22.5 mm (sample 14 in Table 1).

The loose ensemble 2 of cladding tube 1a2 and ARE preform blanks 3 has an outer diameter OD1 which is determined by the outer diameter of the cladding tube 1a2. The ARE preform blanks 3 are bonded to the inner side of the cladding tube 1a2. The ensemble 2 consisting of cladding tube 1a2 and bonded ARE preform blanks 3 can be understood as the first intermediate product 4 (VP1) in terms of the invention; it is subjected to a multi-stage thermal stretching process.

### Multi-Stage Thermal Stretching—Method Variant 2

The first intermediate product 4 (VP1) is further processed by first thermal stretching into a second intermediate product 5 (VP2) and the latter is further processed by second thermal stretching into a preform 8.

A small draw ratio AV1 of 1.13 is set during thermal stretching of the first intermediate product 4 (VP1). The ARE preform blanks 3 are deformed only slightly and largely retain their predetermined position and structural integrity, and they are fused to the inner side of the cladding tube 1a2.

In the first stage of the multi-stage thermal stretching process, the second intermediate product 5 (VP2) with the outer diameter OD2 of 80 mm is thus produced by thermal stretching from the first intermediate product 4 (VP1) with the outer diameter OD1 of 90 mm.

The second intermediate product 5 (VP2) is a solid so-called preform blank in which the hollow-core region is surrounded by a sheath region through which hollow channels pass.

In the second stage of the multi-stage thermal stretching process, the second intermediate product 5 (VP2) with the outer diameter OD2 is thermally stretched with a second draw ratio AV2 to produce preform 8 with the outer diameter OD3.

### Further Processing to Form the Preform—Method Variant 2

The second intermediate product 5 (VP2) is further processed by thermal stretching into a preform 8 which has the predetermined core-sheath-cross-sectional structure of the hollow-core fiber. From this, the hollow-core fiber is drawn by means of a standard fiber drawing process.

### Production of a First Intermediate Product—Method Variant 3

In method variant 3, as schematically shown in FIG. 4, the method steps up to the production of the second intermediate product 5 (VP2) are almost the same as in method variant 1. Sample 7 in Table 1 shows the dimensions and draw ratios. Compared to sample 5, the first intermediate product is thermally stretched with an even smaller draw ratio of only 1.08 into a second intermediate product 5 (VP2) having an outer diameter of 38 mm.

The ARE preform blanks 3 are deformed only slightly and largely retain their predetermined position and structural integrity, and they are fused to the inner side of the cladding tube 1a.

The second intermediate product 5 (VP2) is a solid so-called preform blank in which the hollow-core region is surrounded by a sheath region through which hollow channels pass.

### Multi-Stage Thermal Stretching—Method Variant 3

The second intermediate product 5 (VP2) is then elongated in a second thermal stretching process to form a particularly thin, third intermediate product 6 (VP3) having an outer diameter of 10 mm. The third intermediate product 6 (VP3) is also a solid preform blank.

### Further Processing to Form the Preform—Method Variant 3

The third intermediate product 6 (VP3) is further processed to form a preform 8 by overlaying it with an overlay cylinder 7 so as to obtain the predetermined core-sheath cross-sectional structure of the hollow-core fiber. Overlaying using the overlay cylinder 7 takes place on-line during the fiber drawing process for the hollow-core fiber.

1. A method for producing a preform for an anti-resonant hollow-core fiber which comprises a hollow core extending along a longitudinal axis of the fiber and a sheath that surrounds the hollow core and through which hollow channels pass, comprising the following method steps:
(a) providing a first cylindrical intermediate product VP1 that has a first outer diameter OD1,
(b) thermally stretching the first intermediate product VP1 with a first draw ratio AV1 to form a second cylindrical intermediate product VP2 that has a second outer diameter OD2,
(c) thermally stretching the second intermediate product VP2 with a second draw ratio AV2 to form the preform or a third cylindrical intermediate product VP3 which is further processed to form the preform, wherein the preform, or the third intermediate product, has a third outer diameter OD3,
wherein the first draw ratio AV1 is less than 1.4.

2. The method according to claim 1, wherein the second draw ratio AV2 is greater than 1.2, preferably greater than 1.25, and particularly preferably greater than 1.3.

3. The method according to claim 1, wherein the first draw ratio AV1 is less than 1.28 and in particular lies between 1.002 and 1.25.

4. The method according to claim 1, wherein during the thermal stretching of the first intermediate product VP1 according to method step (b), a drawing bulb with a drawing bulb length L_{Z} and a central constriction angle ε is formed, wherein the central constriction angle ε is less than 5 degrees, preferably less than 4 degrees, and particularly preferably less than 3 degrees.

5. The method according to claim 1, wherein the first outer diameter OD1 is in a range of 30 to 230 mm, preferably in a range of 35 to 160 mm, and particularly preferably in a range of 38 to 120 mm.

6. The method according to claim 1, wherein the second outer diameter OD2 is in a range of 25 to 200 mm, preferably in a range of 35 to 120 mm.

7. The method according to claim 1, wherein the third outer diameter OD3 is in a range of 5 to 100 mm, preferably in a range of 8 to 60 mm.

8. The method according to claim 1, wherein the first cylindrical intermediate product VP1 is an ensemble that comprises a cladding tube with a cladding tube longitudinal axis and a wall inner side, as well as a plurality of cylindrical ARE preform blanks arranged on the wall inner side.

9. The method according to claim 8, wherein the first cylindrical intermediate product VP1 comprises a cladding tube with a large wall thickness in a range of 20 to 75 mm and a large outer diameter in a range of 60 to 200 mm.

10. The method according to claim 8, wherein the ARE preform blanks are not fused, or are only fused at points, to the wall inner side of the cladding tube.

11. The method according to claim 1, wherein the second cylindrical intermediate product VP2 is a first core preform.

12. The method according to claim 10, wherein the third cylindrical intermediate product VP3 is a second core preform.

13. The method according to claim 1, wherein the further processing of the third cylindrical intermediate product VP3 comprises thermal stretching of the third intermediate product and simultaneous overlaying using an overlay cylinder.
